(19) United States
(12) Patent Application Publication
(10) Pub. No.: US 2025/0376166 A1
(43) Pub. Date: Dec. 11, 2025

(54) ENERGY RECOVERY CONTROL METHOD FOR VEHICLE, SYSTEM AND VEHICLE

(71) Applicant: Anhui DeepWay Technology Co., Ltd., Hefei (CN)

(72) Inventors: Zhendong ZHAO, Hefei (CN); Hong XIAO, Hefei (CN); Shusen WAN, Hefei (CN); Zecong WU, Hefei (CN); Xuesong ZHAO, Hefei (CN); Tongtong JI, Hefei (CN)

(21) Appl. No.: 18/900,974

(22) Filed: Sep. 30, 2024

(30) Foreign Application Priority Data
Jun. 6, 2024 (CN) 202410734161.7

(51) Int. Cl. B60W 30/18

(52) U.S. Cl. CPC B60W 30/18072; B60W 2510/1005; B60W 2540/12

(57) ABSTRACT

The present disclosure provides an energy recovery control method for a vehicle, a system, and a vehicle. The energy recovery control method for the vehicle includes: obtaining a current gear of the vehicle when an accelerator pedal of the vehicle is not pressed; determining coasting energy recovery torque based on the gear, wherein the coasting energy recovery torque is smaller at a low gear than at a high gear; obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and controlling the vehicle to perform energy recovery according to the coasting energy recovery torque and the braking energy recovery torque.

### CROSS-REFERENCE TO RELATED APPLICATIONS

This application claims priority to Chinese patent application No. 202410734161.7, filed on June 6, 2024, the entire disclosure of which is incorporated herein by reference.

### TECHNICAL FIELD

The present disclosure relates to the technical field of electric vehicles, and in particular to an energy recovery control method for a vehicle, a system, and a vehicle.

### BACKGROUND

Energy recovery of electric vehicles includes coasting energy recovery and braking energy recovery. At present, these two types of energy recovery are independent systems. When the brake pedal is pressed while the coasting energy recovery is in progress, the vehicle exits a coasting energy recovery mode and enters a braking energy recovery mode. In this case, when the opening degree of the brake pedal is relatively small, negative torque of the vehicle may decrease rather than increase. Therefore, in this braking case, the recovery efficiency will be reduced, and the driving smoothness of the vehicle will be degraded.

### SUMMARY

In view of the above technical problem, it is desired to provide an energy recovery control method for a vehicle, a system, and a vehicle, capable of maintaining coasting energy recovery when a brake pedal is pressed while the coasting energy recovery is in progress, and allowing braking energy recovery to be added during the coasting energy recovery, such that negative torque of the vehicle can increase, thereby improving energy recovery efficiency and driving smoothness of the vehicle, so as to provide a good driving experience.

In a first aspect, an energy recovery control method for a vehicle is provided. The method includes:

obtaining a current gear of the vehicle when an accelerator pedal of the vehicle is not pressed;

determining coasting energy recovery torque based on the gear, wherein the coasting energy recovery torque is smaller at a low gear than at a high gear;

obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and

controlling the vehicle to perform energy recovery according to the coasting energy recovery torque and the braking energy recovery torque.

In some examples, the operation of obtaining the brake pedal opening degree of the vehicle and obtaining the braking energy recovery torque according to the brake pedal opening degree and the gear may include:

determining whether the brake pedal is pressed;

obtaining the braking energy recovery torque as zero when the brake pedal is not pressed; and

obtaining the brake pedal opening degree when the brake pedal is pressed, and obtaining the braking energy recovery torque according to the brake pedal opening degree and the gear, wherein the braking energy recovery torque is proportional to the brake pedal opening degree, and the braking energy recovery torque is dependent on the gear.

In some examples, the operation of controlling the vehicle to perform the energy recovery according to the coasting energy recovery torque and the braking energy recovery torque may include:

obtaining energy recovery torque according to the coasting energy recovery torque and the braking energy recovery torque, wherein the energy recovery torque is a sum of the coasting energy recovery torque and the braking energy recovery torque; and

controlling the vehicle to perform the energy recovery according to the braking energy recovery torque.

In some examples, the operation of controlling the vehicle to perform the energy recovery according to the braking energy recovery torque may include:

controlling, when the brake pedal is not pressed, the vehicle to perform coasting energy recovery according to the braking energy recovery torque; or

controlling, when the brake pedal is pressed, the vehicle to perform braking energy recovery while performing coasting energy recovery according to the braking energy recovery torque.

In some examples, the method may further include, prior to determining the coasting energy recovery torque based on the gear:

determining whether a coasting energy recovery mode is enabled;

performing, when the coasting energy recovery mode is enabled, the step of determining the coasting energy recovery torque based on the gear;

obtaining, when the coasting energy recovery mode is not enabled and when the brake pedal is pressed, the braking energy recovery torque based on the brake pedal opening degree and the gear, and controlling the vehicle to perform braking energy recovery according to the braking energy recovery torque.

In a second aspect, an energy recovery control system for a vehicle is provided. The system includes:

an obtaining module configured to obtain a current gear of the vehicle when an accelerator pedal of the vehicle is not pressed;

a coasting energy recovery torque determining module configured to determine coasting energy recovery torque based on the gear, wherein the coasting energy recovery torque is smaller at a low gear than at a high gear;

a braking energy recovery torque determining module configured to obtain a brake pedal opening degree of the vehicle, and obtain braking energy recovery torque according to the brake pedal opening degree and the gear, wherein given a same brake pedal opening degree, the braking energy recovery torque is greater at a low gear than at a high gear; and

a control module configured to control the vehicle to perform energy recovery according to the coasting energy recovery torque and the braking energy recovery torque.

In a third aspect, a vehicle is provided. The vehicle includes the energy recovery control system for the vehicle according to the second aspect described above.

In a fourth aspect, a computer device is provided. The computer device includes a memory, a processor, and a computer program stored in the memory and executable on the processor. The processor is configured to, when executing the program, perform the steps of the energy recovery control method for the vehicle according to the first aspect and any possible implementation thereof.

In a fifth aspect, a computer-readable storage medium is provided. The computer-readable storage medium has a computer program stored thereon. The program, when executed by a processor, implements the steps of the energy recovery control method for the vehicle according to the first aspect and any possible implementation thereof.

In a sixth aspect, a computer program product is provided. The computer program product has a computer program stored thereon. The program, when executed by a processor, implements the steps of the energy recovery control method for the vehicle according to the first aspect and any possible implementation thereof.

According to the embodiment of the present disclosure, when an accelerator pedal of the vehicle is not pressed, the current gear of the vehicle is obtained. The coasting energy recovery torque is determined according to the gear, and the brake pedal opening degree of the vehicle is obtained. According to the brake pedal opening degree and the gear, the braking energy recovery torque is obtained, and then, according to the coasting energy recovery torque and the braking energy recovery torque, the vehicle is controlled to perform energy recovery. During the coasting energy recovery, after the brake pedal is pressed, the coasting energy recovery is maintained, and in the process of coasting energy recovery, the braking energy recovery is added, such that the negative torque of the vehicle can increase, thereby improving the energy recovery efficiency while improving the driving smoothness of the vehicle, so as to provide a good driving experience. Compared with the related art where, when the brake pedal is pressed during the coasting energy recovery, the vehicle will exit the coasting energy recovery and enter the braking energy recovery, and when the pedal opening degree is relatively small, the negative torque of the vehicle may decrease rather than increase, resulting in low energy recovery efficiency and degraded driving smoothness of the vehicle, the present disclosure can improve the energy recovery efficiency while improving the driving smoothness of the vehicle, thereby providing a good driving experience.

### BRIEF DESCRIPTION OF DRAWINGS

Other features, objects, and advantages of the present disclosure will become more apparent from the detailed description of the non-limiting embodiments given with reference to the following figures, in which

FIG. 1 is a flowchart of an energy recovery control method for a vehicle according to an embodiment of the present disclosure;

FIG. 2 is a schematic diagram showing an energy recovery curve of an energy recovery control method for a vehicle according to an embodiment of the present disclosure;

FIG. 3 is a block diagram showing a structure of an energy recovery control system for a vehicle according to an embodiment of the present disclosure; and

FIG. 4 is a block diagram showing a structure of a computer device according to an embodiment of the present disclosure.

### DESCRIPTION OF EMBODIMENTS

The present disclosure will be further described in detail below in conjunction with the embodiments and drawings. It can be understood that the specific embodiments described herein are only used to explain, rather than limit, the relevant application. It should also be noted that, for the convenience of description, only the parts related to the application are shown in the figures.

It should be noted that, the embodiments in the present disclosure, that is, the features of the embodiments, can be combined with each other, provided that they do not conflict. The present disclosure will be described in detail below with reference to the figures and in conjunction with the embodiments.

An energy recovery control method for a vehicle, a system, and a vehicle according to the embodiments of the present disclosure will be described in detail below with reference to the figures.

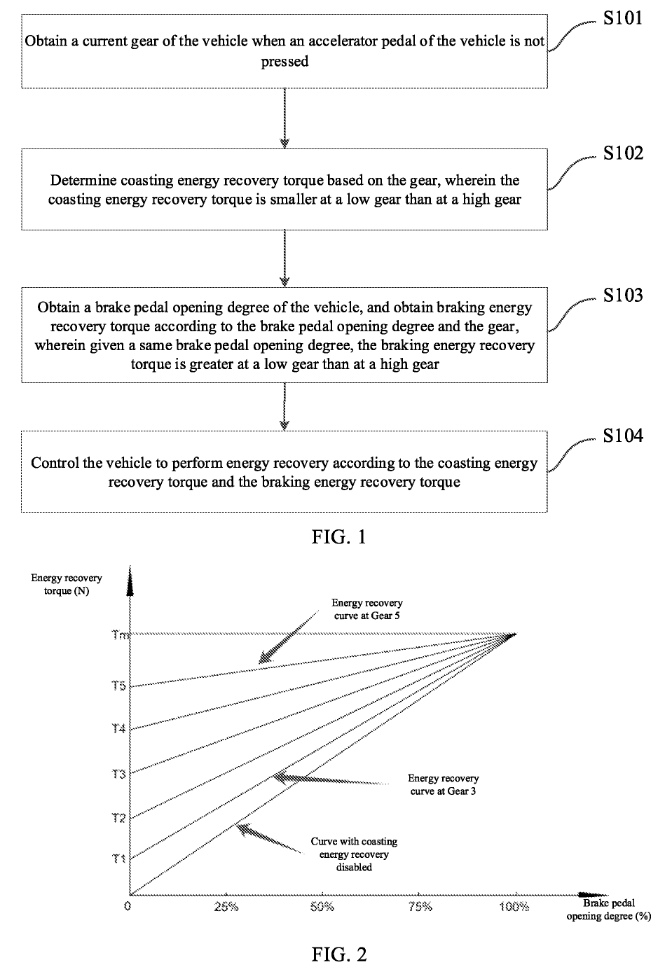

FIG. 1 is a flowchart of an energy recovery control method for a vehicle according to an embodiment of the present disclosure. As shown in FIG. 1, the energy recovery control method for the vehicle according to the embodiment of the present disclosure includes the following steps.

At S101, when an accelerator pedal of the vehicle is not pressed, a current gear of the vehicle is obtained.

During the driving process of the vehicle, when the accelerator pedal is not pressed, the current gear of the vehicle is obtained. For example, when the brake (brake pedal) is pressed, or when the accelerator (accelerator pedal) is released but the brake is not pressed, the current gear of the vehicle is obtained.

At S102, coasting energy recovery torque is determined based on the gear. The coasting energy recovery torque is smaller at a low gear than at a high gear.

Specifically, given certain weight of the whole vehicle, the coasting energy recovery torque when the vehicle is at a low gear is smaller than the coasting energy recovery torque when the vehicle is at a relatively high gear. For example: the forward gears of the vehicle include the first gear, the second gear, the third gear, the fourth gear, and the fifth gear, and the coasting energy recovery torque is T_{coast}, the coasting energy recovery torque at the first gear T_{coast} = T₁, the coasting energy recovery torque at the second gear T_{coast} = T₂, the coasting energy recovery torque at the third gear T_{coast} = T₃, the coasting energy recovery torque at the fourth gear T_{coast} = T₄, and the coasting energy recovery torque at the fifth gear T_{coast} = T₅. Given the weight of the whole vehicle, T₁<T₂<T₃<T₄<T₅.

As shown in FIG. 2, assuming that Tm is the maximum energy recovery torque, then T₅≤Tm. When the brake pedal opening degree is 0 (i.e., when the brake pedal is not pressed), the value of point T₁ on the vertical axis is the coasting energy recovery torque at the first gear, and accordingly, the value of point T₂ on the vertical axis is the coasting energy recovery torque at the second gear, the value of point T₃ on the vertical axis is the coasting energy recovery torque at the third gear, the value of point T₄ on the vertical axis is the coasting energy recovery torque at the fourth gear, and the value of point T₅ on the vertical axis is the coasting energy recovery torque at the fifth gear.

The coasting energy recovery is explained as follows. When the gear is adjusted using a lever, when the driver releases the accelerator pedal and does not press the brake pedal during the driving process of the vehicle, the vehicle controller VDCU calculates different negative torque requests according to the current coasting energy recovery gear and the vehicle weight, and provides them to a motor controller MCU. The motor controller MCU controls a drive motor to execute the negative torque. In this case, the drive motor becomes a generator to generate electricity, and can convert the kinetic energy of the vehicle into electrical energy to achieve the purpose of energy recovery, and generate negative traction to slow down the vehicle.

It should be noted that the higher the gear and the heavier the vehicle is, the greater the energy recovery power and the greater the deceleration will be.

In this step, when the accelerator pedal of the vehicle is not pressed, the coasting energy recovery torque is determined based on the gear. That is, regardless of whether the brake pedal is pressed or not, the coasting energy recovery torque can be determined based on the gear.

At S103, a brake pedal opening degree of the vehicle is obtained, and braking energy recovery torque is obtained according to the brake pedal opening degree and the gear. Given a same brake pedal opening degree, the braking energy recovery torque is greater at a low gear than at a high gear.

In an embodiment of the present disclosure, the operation of obtaining the brake pedal opening degree of the vehicle and obtaining the braking energy recovery torque according to the brake pedal opening degree and the gear may include: determining whether the brake pedal is pressed; obtaining the braking energy recovery torque as zero when the brake pedal is not pressed; and obtaining the brake pedal opening degree when the brake pedal is pressed, and obtaining the braking energy recovery torque according to the brake pedal opening degree and the gear. The braking energy recovery torque is proportional to the brake pedal opening degree, and the braking energy recovery torque is dependent on the gear.

The braking energy recovery is achieved by a braking system. During the driving process of the vehicle, when the driver presses the brake pedal to slow down the vehicle, a braking system controller sends different negative torque percentage requests to a vehicle controller VDCU according to the brake pedal opening degree and the vehicle weight. The vehicle controller VDCU calculates the torque each drive motor should apply according to the request from the braking system controller and sends it to a motor controller MCU. The motor controller MCU controls the drive motor to apply the negative torque. In this case, the drive motor becomes a generator to generate electricity, converting the kinetic energy of the vehicle into electrical energy to achieve the purpose of energy recovery, and generates negative traction to slow down the vehicle. Generally, the larger the pedal opening degree and the heavier the vehicle is, the greater the energy recovery power and the greater the deceleration will be.

It should be noted that given the same brake pedal opening degree and the vehicle weight, the braking energy recovery torque is typically greater at a low gear than at a high gear. It can be clearly seen from FIG. 2 that under given a certain brake pedal opening degree, the slope of the energy recovery torque curve corresponding to a low gear is greater than the slope of the energy recovery torque curve corresponding to a high gear at different gears. Therefore, the braking energy recovery torque at the low gear is typically greater than the braking energy recovery torque at the high gear.

The braking energy recovery torque is T_{brake}. 0≤T_{brake}≤Tₘ. T_{brake} is proportional to the opening degree of the brake pedal. The energy recovery torque is T, in the coasting state T=T_{coast}, and in the braking process, the energy recovery torque T= T_{coast} + T_{brake}. The curve relationship between T and the brake pedal opening degree is affected by the coasting energy recovery gear. The relationship between the brake pedal opening degree and the energy recovery torque is shown in FIG. 2.

At S104, the vehicle is controlled to perform energy recovery according to the coasting energy recovery torque and the braking energy recovery torque.

In an embodiment of the present disclosure, as shown in FIG. 2, the operation of controlling the vehicle to perform the energy recovery according to the coasting energy recovery torque and the braking energy recovery torque may include: obtaining energy recovery torque according to the coasting energy recovery torque and the braking energy recovery torque, wherein the energy recovery torque is a sum of the coasting energy recovery torque and the braking energy recovery torque; and controlling the vehicle to perform the energy recovery according to the braking energy recovery torque.

In this example, the operation of controlling the vehicle to perform the energy recovery according to the braking energy recovery torque may include: controlling, when the brake pedal is not pressed, the vehicle to perform coasting energy recovery according to the braking energy recovery torque; or controlling, when the brake pedal is pressed, the vehicle to perform braking energy recovery while performing coasting energy recovery according to the braking energy recovery torque.

That is, in the embodiment of the present disclosure, the braking energy recovery is added on the basis of the coasting energy recovery, such that the energy recovery efficiency can be effectively improved.

With the energy recovery control method for the vehicle according to the embodiment of the present disclosure, when an accelerator pedal of the vehicle is not pressed, the current gear of the vehicle is obtained. The coasting energy recovery torque is determined according to the gear, and the brake pedal opening degree of the vehicle is obtained. According to the brake pedal opening degree and the gear, the braking energy recovery torque is obtained, and then, according to the coasting energy recovery torque and the braking energy recovery torque, the vehicle is controlled to perform energy recovery. During the coasting energy recovery, after the brake pedal is pressed, the coasting energy recovery is maintained, and in the process of coasting energy recovery, the braking energy recovery is added, such that the negative torque of the vehicle can increase, thereby improving the energy recovery efficiency while improving the driving smoothness of the vehicle, so as to provide a good driving experience. Compared with the related art where, when the brake pedal is pressed during the coasting energy recovery, the vehicle will exit the coasting energy recovery and enter the braking energy recovery, and when the pedal opening degree is relatively small, the negative torque of the vehicle may decrease rather than increase, resulting in low energy recovery efficiency and degraded driving smoothness of the vehicle, the present disclosure can improve the energy recovery efficiency while improving the driving smoothness of the vehicle, thereby providing a good driving experience.

In an embodiment of the present disclosure, the energy recovery control method for the vehicle may further include, prior to determining the coasting energy recovery torque based on the gear: determining whether a coasting energy recovery mode is enabled; performing, when the coasting energy recovery mode is enabled, the step of determining the coasting energy recovery torque based on the gear; obtaining, when the coasting energy recovery mode is not enabled and when the brake pedal is pressed, the braking energy recovery torque based on the brake pedal opening degree and the gear, and controlling the vehicle to perform braking energy recovery according to the braking energy recovery torque. That is, the coasting energy recovery mode can be enabled or disabled as needed. For example, if the driver desires a driving condition with a longer coasting distance, the coasting energy recovery mode can be disabled, thereby better meeting the driving requirements. When the driver needs more energy saving, the coasting energy recovery mode can be enabled, thereby effectively improving the vehicle's cruising range.

In the above description, the vehicle typically refers to an electric commercial vehicle.

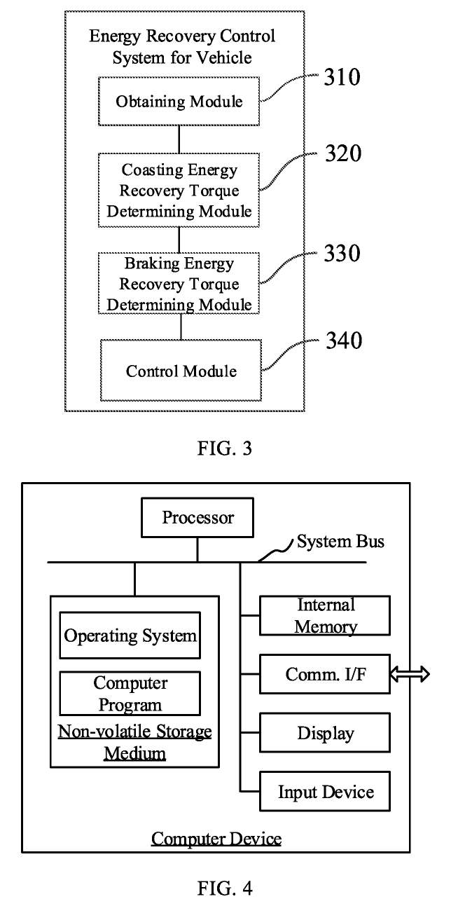

FIG. 3 is a block diagram showing a structure of an energy recovery control system for a vehicle according to an embodiment of the present disclosure. As shown in FIG. 3, the energy recovery control system for the vehicle according to an embodiment of the present disclosure includes: an obtaining module 310, a coasting energy recovery torque determining module 320, a braking energy recovery torque determining module 330, and a control module 340.

The obtaining module 310 is configured to obtain a current gear of the vehicle when an accelerator pedal of the vehicle is not pressed.

The coasting energy recovery torque determining module 320 is configured to determine coasting energy recovery torque based on the gear, wherein the coasting energy recovery torque is smaller at a low gear than at a high gear.

The braking energy recovery torque determining module 330 is configured to obtain a brake pedal opening degree of the vehicle, and obtain braking energy recovery torque according to the brake pedal opening degree and the gear. Given a same brake pedal opening degree, the braking energy recovery torque is greater at a low gear than at a high gear.

The control module 340 is configured to control the vehicle to perform energy recovery according to the coasting energy recovery torque and the braking energy recovery torque.

With the energy recovery control system of the vehicle according to the embodiment of the present disclosure, when an accelerator pedal of the vehicle is not pressed, the current gear of the vehicle is obtained. The coasting energy recovery torque is determined according to the gear, and the brake pedal opening degree of the vehicle is obtained. According to the brake pedal opening degree and the gear, the braking energy recovery torque is obtained, and then, according to the coasting energy recovery torque and the braking energy recovery torque, the vehicle is controlled to perform energy recovery. During the coasting energy recovery, after the brake pedal is pressed, the coasting energy recovery is maintained, and in the process of coasting energy recovery, the braking energy recovery is added, such that the negative torque of the vehicle can increase, thereby improving the energy recovery efficiency while improving the driving smoothness of the vehicle, so as to provide a good driving experience. Compared with the related art where, when the brake pedal is pressed during the coasting energy recovery, the vehicle will exit the coasting energy recovery and enter the braking energy recovery, and when the pedal opening degree is relatively small, the negative torque of the vehicle may decrease rather than increase, resulting in low energy recovery efficiency and degraded driving smoothness of the vehicle, the present disclosure can improve the energy recovery efficiency while improving the driving smoothness of the vehicle, thereby providing a good driving experience.

For the specific description of the energy recovery control system for the vehicle, reference can be made to the above description of the energy recovery control method for the vehicle, and details thereof will be omitted here. The modules of the above energy recovery control system for the vehicle can be implemented in whole or in part by software, hardware, or any combination thereof. The above modules can be embedded in or independent of a processor in a computer device in the form of hardware, or can be stored in a memory of the computer device in the form of software, such that the processor can invoke and execute the operations corresponding to the above modules.

In an embodiment, a vehicle is provided. The vehicle includes the energy recovery control system for the vehicle according to the above embodiment. With the vehicle, when an accelerator pedal of the vehicle is not pressed, the current gear of the vehicle is obtained. The coasting energy recovery torque is determined according to the gear, and the brake pedal opening degree of the vehicle is obtained. According to the brake pedal opening degree and the gear, the braking energy recovery torque is obtained, and then, according to the coasting energy recovery torque and the braking energy recovery torque, the vehicle is controlled to perform energy recovery. During the coasting energy recovery, after the brake pedal is pressed, the coasting energy recovery is maintained, and in the process of coasting energy recovery, the braking energy recovery is added, such that the negative torque of the vehicle can increase, thereby improving the energy recovery efficiency while improving the driving smoothness of the vehicle, so as to provide a good driving experience. Compared with the related art where, when the brake pedal is pressed during the coasting energy recovery, the vehicle will exit the coasting energy recovery and enter the braking energy recovery, and when the pedal opening degree is relatively small, the negative torque of the vehicle may decrease rather than increase, resulting in low energy recovery efficiency and degraded driving smoothness of the vehicle, the present disclosure can improve the energy recovery efficiency while improving the driving smoothness of the vehicle, thereby providing a good driving experience.

In an embodiment, a computer device is provided. FIG. 4 is a block diagram showing a structure of a computer device according to an embodiment of the present disclosure. With reference to FIG. 4, the computer device includes a memory and a processor. The memory stores a computer program, and the processor is configured to, when executing the computer program, implement the energy recovery control method for the vehicle according to the above embodiment, including e.g.,:

obtaining a current gear of the vehicle when an accelerator pedal of the vehicle is not pressed;

determining coasting energy recovery torque based on the gear, wherein the coasting energy recovery torque is smaller at a low gear than at a high gear;

obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and

controlling the vehicle to perform energy recovery according to the coasting energy recovery torque and the braking energy recovery torque.

An embodiment of the present disclosure also provides a computer-readable storage medium. The computer-readable storage medium stores a computer program. The processor is configured to, when executing the computer program, implement the energy recovery control method for the vehicle according to the above embodiment, including e.g.,:

obtaining a current gear of the vehicle when an accelerator pedal of the vehicle is not pressed;

determining coasting energy recovery torque based on the gear, wherein the coasting energy recovery torque is smaller at a low gear than at a high gear;

obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and

controlling the vehicle to perform energy recovery according to the coasting energy recovery torque and the braking energy recovery torque.

An embodiment of the present disclosure provides a computer program product. The computer program product includes instructions which, when executed, perform the method described in the embodiment of the present disclosure. For example, the steps of the energy recovery control method for the vehicle shown in FIG. 1 may be performed, including e.g.,:

obtaining a current gear of the vehicle when an accelerator pedal of the vehicle is not pressed;

determining coasting energy recovery torque based on the gear, wherein the coasting energy recovery torque is smaller at a low gear than at a high gear;

obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and

controlling the vehicle to perform energy recovery according to the coasting energy recovery torque and the braking energy recovery torque.

It can be appreciated by those skilled in the art that all or part of the processes in the method of any of the above embodiments may be implemented by a computer program instructing related hardware. The computer program may be stored in a non-volatile computer-readable storage medium, and the computer program, when executed, may include the processes of the method of any of the above embodiments. Here, any reference to memory, storage, database, or other medium as used in any of the embodiments provided in the present disclosure may include at least one of non-volatile and volatile memory. The non-volatile memory may include a Read-Only Memory (ROM), a magnetic tape, a floppy disk, a flash memory, or an optical memory. The volatile memory may include a Random Access Memory (RAM) or an external cache memory. As an illustration and not limitation, a RAM may be in various forms, such as a Static Random Access Memory (SRAM) or a Dynamic Random Access Memory (DRAM).

The technical features of the above embodiments may be combined arbitrarily. To make the description concise, not all possible combinations of the technical features in the above embodiments have been described. However, as long as there is no contradiction in the combination of these technical features, they should be considered to be encompassed by the scope of the present disclosure.

The above embodiments only describe several implementation methods of the present disclosure, and the description is relatively specific and detailed, but it cannot be understood as a limitation on the scope of the patent disclosure. It should be noted that for those skilled in the art, several variations and improvements can be made without departing from the concept of the present disclosure, which all belong to the protection scope of the present disclosure. Therefore, the protection scope of the present disclosure is defined in the claims as attached.

What is claimed is:

1. An energy recovery control method for a vehicle, comprising:
obtaining a current gear of the vehicle when an accelerator pedal of the vehicle is not pressed;
determining coasting energy recovery torque based on the gear, wherein the coasting energy recovery torque is smaller at a low gear than at a high gear;
obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and
controlling the vehicle to perform energy recovery according to the coasting energy recovery torque and the braking energy recovery torque.

2. The method according to claim 1, wherein said obtaining the brake pedal opening degree of the vehicle and obtaining the braking energy recovery torque according to the brake pedal opening degree and the gear comprises:
determining whether the brake pedal is pressed;
obtaining the braking energy recovery torque as zero when the brake pedal is not pressed; and
obtaining the brake pedal opening degree when the brake pedal is pressed, and obtaining the braking energy recovery torque according to the brake pedal opening degree and the gear, wherein the braking energy recovery torque is proportional to the brake pedal opening degree, and the braking energy recovery torque is dependent on the gear.

3. The method according to claim 1, wherein said controlling the vehicle to perform the energy recovery according to the coasting energy recovery torque and the braking energy recovery torque comprises:
obtaining energy recovery torque according to the coasting energy recovery torque and the braking energy recovery torque, wherein the energy recovery torque is a sum of the coasting energy recovery torque and the braking energy recovery torque; and
controlling the vehicle to perform the energy recovery according to the braking energy recovery torque.

4. The method according to claim 3, wherein said controlling the vehicle to perform the energy recovery according to the braking energy recovery torque comprises:
controlling, when the brake pedal is not pressed, the vehicle to perform coasting energy recovery according to the braking energy recovery torque; or
controlling, when the brake pedal is pressed, the vehicle to perform braking energy recovery while performing coasting energy recovery according to the braking energy recovery torque.

5. The method according to claim 1, further comprising, prior to determining the coasting energy recovery torque based on the gear:
determining whether a coasting energy recovery mode is enabled;
performing, when the coasting energy recovery mode is enabled, the step of determining the coasting energy recovery torque based on the gear;
obtaining, when the coasting energy recovery mode is not enabled and when the brake pedal is pressed, the braking energy recovery torque based on the brake pedal opening degree and the gear, and controlling the vehicle to perform braking energy recovery according to the braking energy recovery torque.

6. An energy recovery control system for a vehicle, comprising:
a memory having a program instruction stored thereon; and
a processor configured to, when executing the program instruction, perform operations of:
obtaining a current gear of the vehicle when an accelerator pedal of the vehicle is not pressed;
determining coasting energy recovery torque based on the gear, wherein the coasting energy recovery torque is smaller at a low gear than at a high gear;
obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and
controlling the vehicle to perform energy recovery according to the coasting energy recovery torque and the braking energy recovery torque.

7. The energy recovery control system according to claim 6, wherein said obtaining the brake pedal opening degree of the vehicle and obtaining the braking energy recovery torque according to the brake pedal opening degree and the gear comprises:
determining whether the brake pedal is pressed;
obtaining the braking energy recovery torque as zero when the brake pedal is not pressed; and
obtaining the brake pedal opening degree when the brake pedal is pressed, and obtaining the braking energy recovery torque according to the brake pedal opening degree and the gear, wherein the braking energy recovery torque is proportional to the brake pedal opening degree, and the braking energy recovery torque is dependent on the gear.

8. The energy recovery control system according to claim 6, wherein said controlling the vehicle to perform the energy recovery according to the coasting energy recovery torque and the braking energy recovery torque comprises:
obtaining energy recovery torque according to the coasting energy recovery torque and the braking energy recovery torque, wherein the energy recovery torque is a sum of the coasting energy recovery torque and the braking energy recovery torque; and
controlling the vehicle to perform the energy recovery according to the braking energy recovery torque.

9. The energy recovery control system according to claim 8, wherein said controlling the vehicle to perform the energy recovery according to the braking energy recovery torque comprises:
controlling, when the brake pedal is not pressed, the vehicle to perform coasting energy recovery according to the braking energy recovery torque; or
controlling, when the brake pedal is pressed, the vehicle to perform braking energy recovery while performing coasting energy recovery according to the braking energy recovery torque.

10. The energy recovery control system according to claim 6, wherein the processor is further configured to, when executing the program instruction, perform operations of, prior to determining the coasting energy recovery torque based on the gear:
determining whether a coasting energy recovery mode is enabled;
performing, when the coasting energy recovery mode is enabled, the step of determining the coasting energy recovery torque based on the gear;
obtaining, when the coasting energy recovery mode is not enabled and when the brake pedal is pressed, the braking energy recovery torque based on the brake pedal opening degree and the gear, and controlling the vehicle to perform braking energy recovery according to the braking energy recovery torque.

11. A vehicle, comprising: the energy recovery control system for the vehicle according to claim 6.

12. A non-transitory computer-readable storage medium, having a computer program stored thereon, wherein the program, when executed by a processor, implements an energy recovery control method for a vehicle, the method comprising:
obtaining a current gear of the vehicle when an accelerator pedal of the vehicle is not pressed;
determining coasting energy recovery torque based on the gear, wherein the coasting energy recovery torque is smaller at a low gear than at a high gear;
obtaining a brake pedal opening degree of the vehicle, and obtaining braking energy recovery torque according to the brake pedal opening degree and the gear, wherein given a same brake pedal opening degree, the braking energy recovery torque is greater at a low gear than at a high gear; and
controlling the vehicle to perform energy recovery according to the coasting energy recovery torque and the braking energy recovery torque.

13. The non-transitory computer-readable storage medium according to claim 12, wherein said obtaining the brake pedal opening degree of the vehicle and obtaining the braking energy recovery torque according to the brake pedal opening degree and the gear comprises:
determining whether the brake pedal is pressed;
obtaining the braking energy recovery torque as zero when the brake pedal is not pressed; and
obtaining the brake pedal opening degree when the brake pedal is pressed, and obtaining the braking energy recovery torque according to the brake pedal opening degree and the gear, wherein the braking energy recovery torque is proportional to the brake pedal opening degree, and the braking energy recovery torque is dependent on the gear.

14. The non-transitory computer-readable storage medium according to claim 12, wherein said controlling the vehicle to perform the energy recovery according to the coasting energy recovery torque and the braking energy recovery torque comprises:
obtaining energy recovery torque according to the coasting energy recovery torque and the braking energy recovery torque, wherein the energy recovery torque is a sum of the coasting energy recovery torque and the braking energy recovery torque; and
controlling the vehicle to perform the energy recovery according to the braking energy recovery torque.

15. The non-transitory computer-readable storage medium according to claim 14, wherein said controlling the vehicle to perform the energy recovery according to the braking energy recovery torque comprises:
controlling, when the brake pedal is not pressed, the vehicle to perform coasting energy recovery according to the braking energy recovery torque; or
controlling, when the brake pedal is pressed, the vehicle to perform braking energy recovery while performing coasting energy recovery according to the braking energy recovery torque.

16. The non-transitory computer-readable storage medium according to claim 12, wherein the method further comprises, prior to determining the coasting energy recovery torque based on the gear:
determining whether a coasting energy recovery mode is enabled;
performing, when the coasting energy recovery mode is enabled, the step of determining the coasting energy recovery torque based on the gear;
obtaining, when the coasting energy recovery mode is not enabled and when the brake pedal is pressed, the braking energy recovery torque based on the brake pedal opening degree and the gear, and controlling the vehicle to perform braking energy recovery according to the braking energy recovery torque.

17. A computer program product, having a computer program stored thereon, the program, when executed by a processor, implements the energy recovery control method for the vehicle according to claim 1.

18. The computer program product according to claim 17, wherein said obtaining the brake pedal opening degree of the vehicle and obtaining the braking energy recovery torque according to the brake pedal opening degree and the gear comprises:
determining whether the brake pedal is pressed;
obtaining the braking energy recovery torque as zero when the brake pedal is not pressed; and
obtaining the brake pedal opening degree when the brake pedal is pressed, and obtaining the braking energy recovery torque according to the brake pedal opening degree and the gear, wherein the braking energy recovery torque is proportional to the brake pedal opening degree, and the braking energy recovery torque is dependent on the gear.

19. The computer program product according to claim 17, wherein said controlling the vehicle to perform the energy recovery according to the coasting energy recovery torque and the braking energy recovery torque comprises:
obtaining energy recovery torque according to the coasting energy recovery torque and the braking energy recovery torque, wherein the energy recovery torque is a sum of the coasting energy recovery torque and the braking energy recovery torque; and
controlling the vehicle to perform the energy recovery according to the braking energy recovery torque.

20. The computer program product according to claim 19, wherein said controlling the vehicle to perform the energy recovery according to the braking energy recovery torque comprises:
controlling, when the brake pedal is not pressed, the vehicle to perform coasting energy recovery according to the braking energy recovery torque; or
controlling, when the brake pedal is pressed, the vehicle to perform braking energy recovery while performing coasting energy recovery according to the braking energy recovery torque.
